(19) United States
(12) Patent Application Publication
(10) Pub. No.: US 2011/0094796 A1
(43) Pub. Date: Apr. 28, 2011

(54) Wire harness

(75) Inventors: Eiichi Toyama, Kosai (JP); Shigemi Hashizawa, Kosai (JP)

(73) Assignee: Yazaki Corporation, Tokyo (JP)

(21) Appl. No.: 12/926,105

(22) Filed: Oct. 26, 2010

(30) Foreign Application Priority Data
Oct. 28, 2009 (JP) 2009-247507

(51) Int. Cl. H02G 3/04

(52) U.S. Cl. 174/72 A

(57) ABSTRACT

A wire harness is wired at a predetermined position of the hybrid vehicle 1. The wire harness includes a plurality of high-voltage electric wires and the low-voltage electric wire and a protection member in which a portion-to-be-protected of the plurality of electric wires is inserted in a lump. The protection member protects the plurality of high-voltage electric wires and the low-voltage electric wires. The protection member is constituted of a bendable long standard pipe.

### CROSS REFERENCE TO RELATED APPLICATION

The priority application Japan Patent Application No. 2009-247507 upon which this patent application is based is hereby incorporated by reference.

### BACKGROUND OF THE INVENTION

1. Field of the Invention

The present invention generally relates to a wire harness including one or more electric wires and a protection member in which a portion-to-be-protected of the plurality of electric wires is inserted in a lump to be protected.

2. Description of the Related Art

In a vehicle such as an automobile, a wire harness is wired along a complexly-curved path. A wire harness disclosed in the Japanese Patent Application Publication No. 2005-80380 includes a plurality of electric wires having a terminal at an end thereof, and a plurality of protectors made of synthetic resin. The plurality of electric wires is received in and protected by various protectors having a suitable shape according to the wiring position. The various protectors correspond to a protection member which protects the plurality of electric wires as a bundle. The various protectors are formed into various shapes.

### SUMMARY OF THE INVENTION

### Problems to be Solved

However, the conventional wire harness described above has a problem that, since the conventional wire harness requires the protectors which are designed into suitable shapes according to the various wiring positions, there is a need for designing these protectors for each of the different vehicles. As a result, the manufacture cost is increased.

Furthermore, there is a problem that, since the conventional protector is exclusive for the vehicle to which the wire harness is wired, it is difficult to apply this conventional protector in different vehicles. As a result, the conventional protector lacks versatility. In addition, there is a problem that a need for producing a tooling causes a further increase in the manufacturing cost.

The above-described problems may arise also for the wire harness applied in a hybrid vehicle and an electric vehicle.

In view of the above-described problems, an object of the present invention is to provide the wire harness in which a designing of the protection member is achieved at substantially the same time as a wiring design of the wire harness, in which the versatility of the protection member is improved, and in which the manufacturing cost can be reduced.

### Solution to Problems

In order to attain the above objective, there is provided a wire harness according to the present invention having: one or more electric wires; a protection member into which a portion-to-be-protected of the one or more electric wires is inserted in a lump to be protected. The protection member is constituted of a standard pipe selected from the group consisting of a bendable long standard pipe and a connected short standard pipe, the connected short standard pipe being lengthened by connecting a plurality of bendable short standard pipes to each other via a connecting member. The one or more electric wires are constituted of an electric wire selected from the group consisting of a shielded electric wire having a shielding function and an electric wire with a shielding material covering the one or more electric wires in a lump, eliminating the need for providing the shielding function of the long standard pipe and the connected short standard pipe as the protection member.

According to the present invention described above, the protection member constituting the wire harness is formed with the long standard pipe or the connected short standard pipe. The long standard pipe or the connected short standard pipe may be a commercially available standard pipe or a standard pipe designed for a use in various vehicles. In addition, according to the present invention, the shielding function is provided to the electric wire to maintain the simple structure of the protection member. The shielding member is preferably, but not limited to, a braid or a metallic foil.

Furthermore, according to the present invention, in a case of using the plurality of bendable short standard pipes, when the short standard pipes are not yet connected to each other, the wire harness can be rounded up or folded to be packed. Consequently, for example a space required for transporting the wire harness can be minimized (a packing of the wire harness can be downsized), increasing a number of wire harnesses to be transported and thus the cont can be reduced.

Furthermore, there is provided the wire harness described above having a fixing clamp provided to the long standard pipe or the connected short standard pipe.

According to the present invention described above, the long standard pipe or the connected short standard pipe has the fixing clamp used when fixing the wire harness when wiring the wire harness. Since the structure of the long standard pipe itself or the connected standard pipe itself is simple, the structure of the clamp can also be simple.

Furthermore, there is provided the wire harness described above in which the one or more electric wires are high-voltage electric wires for a hybrid vehicle or for an electric vehicle.

According to the present invention described above, the wire harness can be suitable to be wired to the hybrid vehicle or to the electric vehicle.

Furthermore, there is provided the wire harness described above in which the long standard pipe and the connected short standard pipe are made of a material selected from the group consisting of metal and resin, depending on a usage environment of the wire harness.

According to the present invention described above, by forming the protection member with the metallic standard pipe, the protection member can achieve a high protection performance.

### ADVANTAGEOUS EFFECT OF THE INVENTION

According to the present invention, since the protection member constituting the wire harness is formed with the long or short standard pipe, the designing of the protection member can be achieved at substantially the same time as the wiring design of the wire harness. Furthermore, according to the present invention, by using the long or short standard pipe, the versatility of the protection member can be improved and thus the manufacturing cost can be reduced. Furthermore, according to the present invention, since the long or short standard pipe as the protection member can be bent, the protection member can be used for the various different vehicles. Furthermore, since the electric wire is provided with the shielding function, the simple structure of the protection member can be maintained. Furthermore, by using the standard pipe having the simple structure the manufacturing cost of the wire harness can be reduced.

Furthermore, according to the present invention, the wire harness can be wired by fixing the wire harness in a suitable manner.

Furthermore, according to the present invention, the wire harness can be provided not only to the ordinary vehicles but also to the hybrid vehicle and to the electric vehicle, thereby reducing the manufacturing cost.

Furthermore, according to the present invention, the protection member made of metal can achieve a high protection performance and can be a heat resistant member. In addition, the protection member made of synthetic resin can provide the wire harness with reduced weight.

### BRIEF DESCRIPTION OF THE DRAWINGS

FIGS. 1A, 1B and 1C are diagrammatic illustrations showing a wire harness of the present invention according to a first and a third embodiment, in which FIG. 1A shows the entire wire harness, FIG. 1B shows an one end of the wire harness, and

FIG. 1C shows the other end of the wire harness; and

FIGS. 2A, 2B, 2C and 2D are diagrammatic illustrations showing a wire harness of the present invention according to a second and the third embodiment, in which FIG. 2A shows the entire wire harness, FIG. 2B shows an one end of the wire harness, FIG. 2C shows the other end of the wire harness, and FIG. 2D is a diagram explaining a connection by a connection member.

### DETAILED DESCRIPTION OF THE INVENTION

A wire harness includes a protection member constituted of a standard pipe in which a portion-to-be-protected of one or more electric wires is inserted in a lump to be protected by the protection member.

### A First Exemplary Embodiment

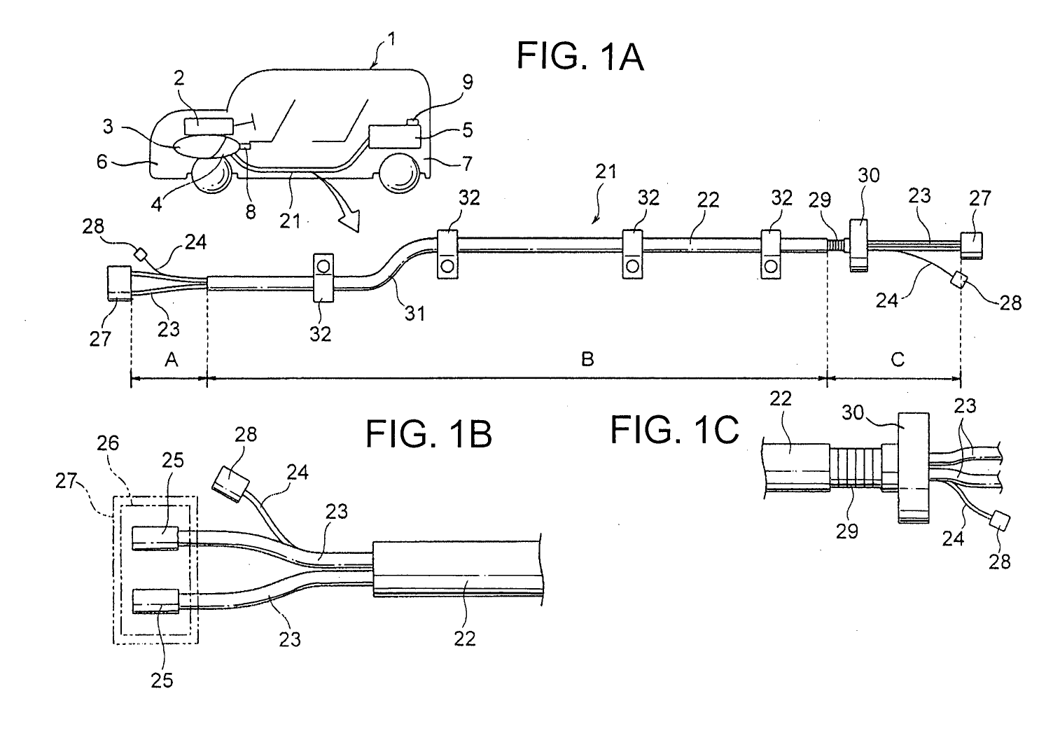

The following describes a first exemplary embodiment with reference to FIGS. 1A through 1C showing a wire harness according to the present invention.

The wire harness according to the first embodiment of the present invention corresponds to the one to be wired in a hybrid vehicle or in an electric vehicle. The following describes for the case of the hybrid vehicle. It will be understood that a constitution, a structure and advantageous effects of the wire harness according to the present invention is basically the same for the case of an application to an electric vehicle. It will also be understood that the present invention may be applied to an ordinary vehicle and such, in addition to the hybrid vehicle and the electric vehicle.

In FIG. 1A, the hybrid vehicle 1 is driven by a combination of an engine 2 and a motor 3, and a power from a battery 5 is supplied to the motor 3 via an inverter 4. In this embodiment, the engine 2, the motor 3 and the inverter 4 are mounted at a vehicle front portion 6 inside the vehicle in which front wheels and such are provided. The battery 5 is mounted at a vehicle rear portion 7 inside the vehicle in which rear wheels and such are provided. A reference sign 8 shown at the vehicle front portion 6 indicates an electric junction box such as a known relay box. In addition, a reference sign 9 shown at the vehicle rear portion 7 indicates a known low-voltage battery which may be arranged at an arbitral position.

In this embodiment, the motor 3 includes a motor and a generator, and the inverter 4 includes an inverter and a converter. The inverter 4 is an inverter assembly including an air conditioning inverter, an inverter for a generator, an inverter for a motor and such. The battery 5 may be a Ni-MH (Nickel metal hydride) battery or a lithium-ion battery arranged as a module. Also, an electrical storage device such as a capacitor may be used. The battery 5 may be any battery which can be used in the hybrid vehicle and the electric vehicle.

The inverter 4 and the battery 5 are connected by a wire harness 21 of the present invention.

The wire harness 21 is to be wired at a predetermined position of the hybrid vehicle 1. The wire harness 21 includes a plurality of electric wires (or may be a single electric wire) and a protection member in which a portion-to-be-protected of the plurality of electric wires is inserted in a lump to be protected by the protection member. The protection member is formed with a long standard pipe 22 constituted of a long and bendable standard pipe to protect the plurality of electric wires.

In this embodiment, the above-described plurality of electric wires is constituted of, but not limited to, a plurality of high-voltage electric wires 23 and low-voltage electric wires 24. Alternatively, the plurality of electric wires may be constituted of the low-voltage electric wires 24 only, or may be constituted of the high-voltage electric wires 23 only. The high-voltage electric wire 23 is thicker than the low-voltage electric wire 24, and a conductive wire thereof at a center is made of copper, copper alloy or aluminum. There are provided two high-voltage electric wires 23 in this embodiment (the number of the electric wires 23 may be chosen arbitrarily). The high-voltage electric wire 23 is a shielded wire having a shielding function and is constituted of a conductive core wire and a shielding member such as a braid. The conductive core wire at an end of the high-voltage electric wires 23 is connected with a terminal 25. The conductive core wire may be constituted of a twisted wire element or may be the one having a stick-like shape with a rectangular or a circular cross section such as a rectangular wire. In addition, the shielding member is connected to an earth portion 26. The respective terminals 25 are received and fixed inside an insulating housing (not shown). The earth portion 26 is provided outside the housing, and a connector 27 is arranged so as to include the earth portion 26. To provide the shielding function, the shielding member may be the one which covers a lump of the plurality of high-voltage electric wires 23 (an example of such shielding member includes a braid and a metallic foil). Alternatively, the high-voltage electric wire 23 may be a cabtire cable.

The low-voltage electric wire 24 is provided with a connector 28 arranged at one end thereof. The low-voltage electric wire 24 together with the high-voltage electric wire 23 is protected by the long standard pipe 22 as the protective member. The one end of the low-voltage electric wire 24 is connected with the electric junction box 8 and the other end thereof is connected with the low-voltage battery 9.

A predetermined range B for the plurality of high-voltage electric wires 23 and the low-voltage electric wire 24, which is a range from one end of the electric wire 23, 24 to the other end of the electric wire 23, 24 not including predetermined ranges A and C, is determined as the above-described portion-to-be-protected covered by the long standard pipe 22. The predetermined range herein is described as an example only. If there is a plurality of portions-to-be-protected, a plurality of long standard pipes 22 is employed for the wire harness 21. The portion-to-be-protected includes not only the main portion but a branching portion. In this embodiment, only the main portion is explained.

For a wiring of the wire harness 21, the predetermined range B corresponds to a fixation portion to be fixed. The above-described predetermined range A, C corresponds to a flexible portion having flexibility. The flexible portion of the predetermined range A includes the high-voltage electric wires 23 and the low-voltage electric wire 24 drawn out from one end of the long standard pipe 22. The flexible portion of the predetermined range C is constituted of a corrugated tube 29, a grommet 30, the high-voltage electric wires 23 and the low-voltage electric wire 24.

The corrugated tube 29 is connected to the other end of the long standard pipe 22. An example of a connecting method will be described later. The corrugated tube 29 may be replaced with a twisted tube, rubber material (EPDM), a sheet material or the like. The grommet 30 is attached to the corrugated tube 29 so as to prevent water intrusion at this attachment portion (the grommet 30 is not needed if waterproof function is not required). The high-voltage electric wires 23 and the low-voltage electric wire 24, which are hidden by the grommet 30, are drawn out from an end of the corrugated tube 29.

The long standard pipe 22 is a long, bendable standard pipe as described above and is made of synthetic resin. The long standard pipe 22 does not require a shielding function since the plurality of high-voltage electric wires 23 is the shielded wire. The entire or a part of the long standard pipe 22 may be made of metal to function as, for example, a heat-resistant member, which is described as a third embodiment hereinafter. The long standard pipe 22 is subjected to a bending after a process of inserting the plurality of high-voltage electric wires 23 and the low-voltage electric wire 24 into the long standard pipe 22. Alternatively, the long standard pipe 22 may be subjected to a bending before inserting therein the plurality of high-voltage electric wires 23 and the low-voltage electric wire 24.

The long standard pipe 22 according to this embodiment is formed into a substantially crank shape by bending a portion 31 of the long standard pipe 22 twice. In addition, a portion of the long standard pipe 22 other than the portion 31 is formed straight (the long standard pipe 22 is bent according to a wiring path).

The long standard pipe 22 according to this embodiment is provided with a fixing member 32. The fixing member 32 according to this embodiment corresponds to a clamp exclusive for a pipe. The fixing member 32 includes a portion to be wrapped around an outer face of the length standard pipe 22 and a mounting portion formed so as to be threadably mounted at a portion-to-be-wired not shown (e.g. a portion at which the wire harness 21 is attached, such as a vehicle body panel or a reinforcing material). The fixing member 32 does not need to be the clamp exclusive for the pipe but may be formed by a band, a clip or the like.

The fixing member 32 according to the embodiment is a separate member which is mounted afterward. The shown arrangement and the number of the fixing member 32 are just an example. If the long standard pipe 22 is made of metal, the fixing member 32 is fixed by welding. The standard pipe used for the long standard pipe 22 is formed with a standard diameter. If the standard pipes have a plurality of diameters, a suitable diameter can be chosen arbitrarily depending on the usage condition and the environment.

The following explains, without referring to the drawings, a processing of the one end and the other end of the long standard pipe 22. Firstly, a processing of the other end adjacent to the corrugated tube 29 will be explained.

A slit is formed at a portion of the end of the long standard pipe 22 adjacent to an end face thereof. The slit is formed as a cut parallel to the end face. A tube connection member such as the one with a U-shape is fitted to the slit. The tube connection member connects the corrugated tube 29 with the long standard pipe 22 by being fitted to a gullet portion of the corrugated tube 29 inserted into the long standard pipe 22.

For connecting the corrugated tube 29 with the long standard pipe 22, in addition to using the slit and the U-shape tube connection member, a tube-like rubber product may be used. A preferred rubber product is the one which covers both the long standard pipe 22 and the corrugated tube 29.

Next, a processing of the one end of the long standard pipe 22 is explained. The plurality of high-voltage electric wires 23 and the low-voltage electric wire 24 drawn from the long standard pipe 22 are fixed by a tape such that the end of the long standard pipe 22, the high-voltage electric wires 23 and the low-voltage electric wire 24 are taped together. However, a use of the tape is not a requisite. The same taping is applied for a portion where the high-voltage electric wires 23 and the low-voltage electric wire 24 are drawn out from the corrugated tube 29.

For the above-described constitution and the structure, the wire harness 21 is formed such that the plurality of high-voltage electric wires 23 and the low-voltage electric wire 24 are inserted in a lump into the long standard pipe 22 as the protection member, followed by bending the portion 31 of the long standard pipe 22. The wire harness 21 is wired at the portion-to-be-wired (such as a vehicle body panel or a reinforcing material) by forming the long standard pipe 22 along the wiring path and by threadably fixing the long standard pipe 22 at a predetermined position via the fixing member 32.

As explained above with reference to FIG. 1A, the wire harness 21 according to the present invention is constituted with the long standard pipe 22 as the protection member. Consequently, with this long standard pipe 22, the designing of the protection member and the wiring designing of the wire harness can be achieved at substantially the same speed:

Furthermore, according to the wire harness of the present invention, by using the long standard pipe 22 as the protection member, the versatility of the protection member can be increased and the manufacturing cost can be reduced.

Furthermore, according to the wire harness 21 of the present invention, by using the long standard pipe 22 as the protection member and bending the long standard pipe 22, the wire harness 21 can be applied to various different vehicles.

Furthermore, according to the wire harness 21 of the present invention, by providing the shielding function to the electric wires, the manufacturing cost of the wire harness 21 can be reduced.

Furthermore, according to the wire harness 21 of the present invention, use of the standard pipe having a simple structure can also reduce the manufacturing cost.

### A Second Exemplary Embodiment

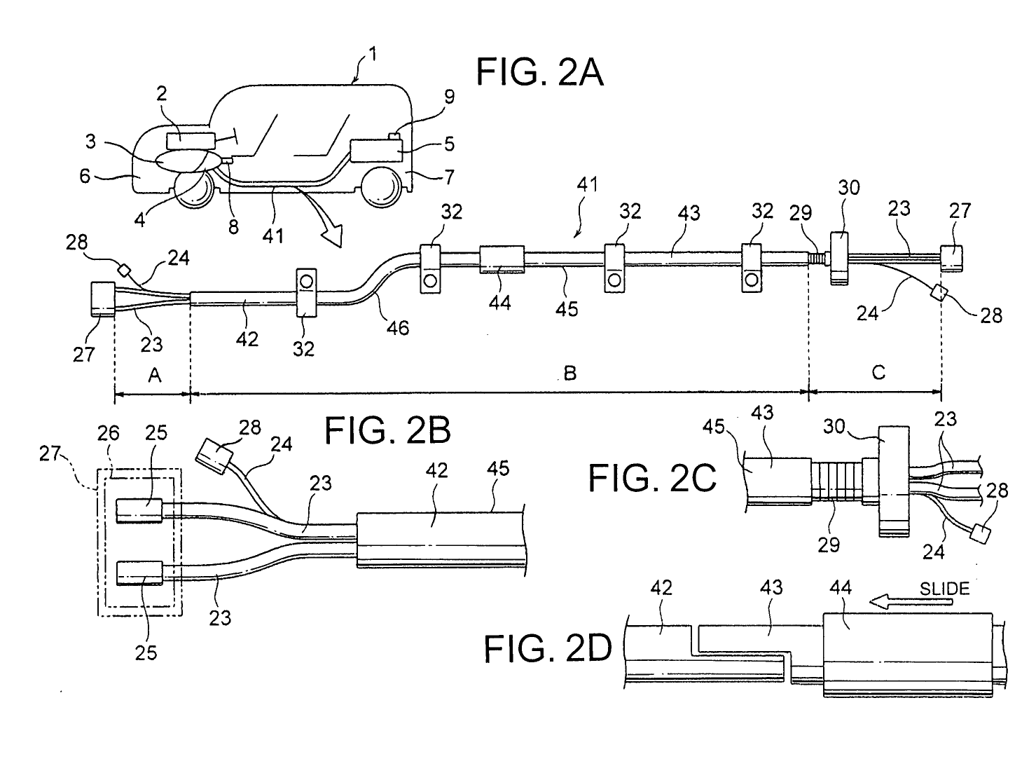

A second exemplary embodiment is described below with reference to the drawings. FIGS. 2A through 2D are diagrammatic illustrations showing a wire harness according to the present invention. The same reference signs are used for the components similar to those of the first embodiment thereby eliminating a detailed explanation.

A wire harness 41 shown in FIG. 2A is to be wired at a predetermined position of a hybrid vehicle 1 and includes a plurality of electric wires (or may be a single electric wire) and a protection member in which a portion-to-be-protected of the plurality of electric wires is inserted in a lump to be protected. The protection member is for a protection of the plurality of electric wires and is formed with a connected short standard pipe 45 formed long by connecting a plurality of short standard pipes 42, 43 via a connecting member 44.

The short standard pipe 42, 43 corresponds to the standard pipe described in the first embodiment formed short, and a length of the short standard pipe 42, 43 is determined according to a type of packing and such of the wire harness 41. Since the plurality of high-voltage electric wires 23 in the drawing is the shielded wire, the short standard pipe 42, 43 does not need to have a shielding function, thus the short standard pipe 42, 43 is made of synthetic resin. The short standard pipe 42, 43 may be made of metal to be heat-resistant in order to wire near a heart source, as described in detail in the third embodiment. The short standard pipe 42, 43 can be bent after the process of inserting the plurality of high-voltage electric wires 23 and the low-voltage electric wire 24 into the short standard pipe 42, 43. Alternatively, the short standard pipe 42, 43 may be bent before inserting therein the plurality of high-voltage electric wires 23 and the low-voltage electric wire 24.

The short standard pipe 42 according to this embodiment is formed into a substantially crank shape by bending a portion 46 of the short standard pipe 42 twice. In addition, a portion of the short standard pipe 42 other than the portion 46 and also the short standard pipe 43 is formed straight (the short standard pipe 42 is bent according to a wiring path). In this embodiment, the connected short standard pipe 45 has two segments including the short standard pipes 42 and 43. However, the number of segments may be other than two. For example, in order to downsize the packaging of the wire harness 41, the wire harness 41 may be divided into more segments to be rounded up or folded.

The connecting member 44 is provided at a portion at which the above-described segments lie next to each other and connects these segments which are the short standard pipes 42 and 43. In this embodiment, an inner diameter of the connecting member 44 is larger than that of the short standard pipe 42, 43. The connecting member 44 is arranged to slide in a direction of a pipe axis and formed to lie astride the short standard pipes 42 and 43 to fix these pipes 42, 43 together. For example, the connecting member 44 may be produced easily by forming a standard pipe having an inner diameter larger than that of the short standard pipe 42, 43 and cutting this standard pipe into a length suitable for connecting the short standard pipes 42, 43. Alternatively, the tube-like rubber product described in the first embodiment may be used as well.

In this embodiment, the wire harness 41 is formed such that the plurality of high-voltage electric wires 23 and the low-voltage electric wire 24 are inserted in a lump into the connected short standard pipe 45 as a protection member, followed by bending the portion 46 of the short standard pipe 42 of the connected short standard pipe 45 into a crank shape. The wire harness 41 is wired at the portion-to-be-wired (such as vehicle body panel or the reinforcement material) by fixed at a predetermined position via the fixing member 32.

As explained above with reference to FIG. 2A, it is obvious that the wire harness 41 according to the present invention has the same advantageous effects as those of the first embodiment.

### A Third Exemplary Embodiment

A third exemplary embodiment is described below with reference to FIGS. 1A through 1C and 2A through 2D. A wire harness according to the third embodiment only differs from the first and the second embodiment in material, and thus the same reference signs are used for the components similar to those of the first and the second embodiment thereby eliminating a detailed explanation.

In the third embodiment, in FIG. 1A, a long standard pipe 22 as a protection member constituting a wire harness 21 is made of metal whereas in the first embodiment the long standard pipe 22 is made of synthetic resin. In addition, in FIG. 2A, a plurality of short standard pipe 42, 43 of a connected short standard pipe 45 as a protection member of the wire harness 41 is also made of metal whereas in the second embodiment the plurality of short standard pipes 42, 43 is made of synthetic resin. The metallic long standard pipe 22 and the metallic plurality of short standard pipe 42, 43 have improved protection performance compared to those made of synthetic resin.

An example of a metallic material is the one made of stainless steel from a standpoint of protection performance and weather resistance. Furthermore, another preferable example is the one made of aluminum from a standpoint of protection performance and reducing weight. In the third embodiment, the long standard pipe 22 and the connected short standard pipe 45 is made of aluminum.

The long standard pipe 22 and the connected short standard pipe 45 do not require the shielding function as explained in the first and the second embodiment. This is because the present invention is intended to maintain a simple structure of the protection member by providing the shielding function to the electric wires. For example, a hybrid vehicle 1 requires a high shielding performance, and if the protection member is formed by the metallic pipe to provide the shielding function, the metallic pipe must be structured so as to completely cover the electric wire (non-shielded wire) with no space left uncovered. Or, if it is difficult to completely cover the electric wire (non-shielded wire), the metallic pipe must be arranged so this metallic pipe is utilized as a minus earth. However, in this case, an improved protection member and the simplified structure of the protection member cannot be achieved at the same time, making the present invention useful.

Furthermore, the reason for using an aluminum material for the long standard pipe 22 and the connected short standard pipe 45 in the third embodiment is that, in addition to improving the protection performance and reducing weight, it is suitable for showing that the shielding function is not provided to the protection member. That is, aluminum becomes an insulating material when oxidized (produce an insulating oxide coating), thereby making it difficult to provide the shielding performance (because it is known that a resistance on a surface of the aluminum increases greatly over time, and thus it is difficult to utilize the metallic pipe as a minus earth unless processed in a suitable manner). In addition, for the long standard pipe 22 and the connected short standard pipe 45 having the structure in which the high-voltage electric wire 23 and such is merely drawn out from the end of the pipe (i.e. there exist an open space), effective shielding cannot be achieved even if the aluminum is not changed into the insulating material as described above. Consequently, it is difficult to perform a high shielding performance with the long standard pipe 22 and the connected short standard pipe 45.

As described above, it is obvious that the wire harness 21 including the metallic long standard pipe 22 and the wire harness 41 including the metallic connected short standard pipe 45 according to the third embodiment have the same advantageous effects as those of the first embodiment and the second embodiment, and that further advantages can be obtained by using metallic material.

In the foregoing description, the present invention has been described with reference to specific embodiments. It is understood that various modifications and changes can be made within the scope of the scope of the invention as set forth in the appended claims.

1. A wire harness comprising:
one or more electric wires;
a protection member into which a portion-to-be-protected at the one or more electric wires is inserted in a lump to be protected by the protection member;
wherein,
the protection member is constituted of a standard pipe selected from the group consisting of a bendable long standard pipe and a connected short standard pipe, the connected short standard pipe being lengthened by connecting a plurality of bendable short standard pipes to each other via a connecting member, and
the one or more electric wires are constituted of an electric wire selected from the group consisting of a shielded electric wire having a shielding function and an electric wire with a shielding material covering the one or more electric wires in a lump, eliminating a need for the shielding function of the long standard pipe and the connected short standard pipe as the protection member.

2. The wire harness according to claim 1, wherein a fixing clamp is provided to the long standard pipe and the connected short standard pipe.

3. The wire harness according to claim 1, wherein the one or more electric wires are high-voltage electric wires for a hybrid vehicle or an electric vehicle.

4. The wire harness according to claim 1, wherein the long standard pipe and the connected short standard pipe are made of a material selected from the group consisting of metal and resin, depending on a usage environment.

5. The wire harness according to claim 2, wherein the one or more electric wires are high-voltage electric wires for a hybrid vehicle or an electric vehicle.

6. The wire harness according to claim 2, wherein the long standard pipe and the connected short standard pipe are made of a material selected from the group consisting of metal and resin, depending on a usage environment.

7. The wire harness according to claim 3, wherein the long standard pipe and the connected short standard pipe are made of a material selected from the group consisting of metal and resin, depending on a usage environment.

8. The wire harness according to claim 5, wherein the long standard pipe and the connected short standard pipe are made of a material selected from the group consisting of metal and resin, depending on a usage environment.
